(19) United States
(12) Patent Application Publication
(10) Pub. No.: US 2011/0235189 A1
(43) Pub. Date: Sep. 29, 2011

(54) Optical imaging system and imaging apparatus

(75) Inventor: Hiroki Yamano, Tokyo (JP)

(73) Assignee: Sony Corporation, Tokyo (JP)

(21) Appl. No.: 12/929,656

(22) Filed: Feb. 7, 2011

(30) Foreign Application Priority Data
Mar. 25, 2010 (JP) 2010-069464

(51) Int. Cl. G02B 7/04; G02B 3/00

(52) U.S. Cl. 359/704; 359/722

(57) ABSTRACT

An optical imaging system includes at least one optical component including an optical filter and a lens, wherein a hard coat is applied to an object side or an image side of an optical surface of the at least one optical component, and the hard coat is formed to be able to come into contact with a different component positioned adjacent thereto or an optical surface of a different optical component positioned adjacent thereto.

### BACKGROUND OF THE INVENTION

1. Field of the Invention

The present invention relates to an optical imaging system and an imaging apparatus. Specifically, the invention relates to a technique of achieving miniaturization of the apparatus while preventing optical surfaces of optical components, which include lenses and optical filters, from being damaged by applying a hard coat to the optical surfaces of the optical components so as to enable them to come into contact with optical surfaces of other optical components or the other components.

2. Description of the Related Art

Recently, there has been an increase in the demand to improve image quality while decreasing the size of the imaging apparatus, such as a digital video camera or digital still camera, having an optical imaging system such as a zoom optical system. In order to cope with the demand, there have been proposed methods of improving image quality and decreasing the size of the imaging apparatus due to a decrease in size of the optical imaging system achieved by mounting the high density CCD (Charge Coupled Device) or the high density CMOS (Complementary Metal Oxide Semiconductor) thereon as a solid-state imaging device.

In such imaging apparatuses, for example, there are apparatuses which have plural lens groups constituting the zoom lens and are configured to change the focal length of the optical system by moving the respective lens groups relative to one another in the direction of the optical axis.

Further, in the imaging apparatuses having such a zoom lens, there are imaging apparatuses which have a so-called collapsible zoom lens which is movable between an accommodated position at which a lens barrel having the plural lens groups arranged therein is accommodated in a camera main body and an extended position to which the lens barrel is projected from the camera main body (for example, refer to JP-A-2009-198800).

In the collapsible zoom lens, when the respective lens groups moved in the direction of the optical axis are positioned to be closest to one another, for example, clearances of about 0.1 mm to 0.5 mm are provided between the lens groups positioned to be close to one another, thereby preventing the lens surfaces (the optical surfaces) from being damaged.

### SUMMARY OF THE INVENTION

However, in the imaging apparatuses in the related art, as described above, clearances are provided between the respective lens groups in the direction of the optical axis. For this reason, by that amount, the entire lengths of the optical imaging system and the imaging apparatus in the direction of the optical axis elongate, and thus this causes a problem in miniaturization.

Therefore, it is desirable to solve the above-mentioned problem and provide an optical imaging system and an imaging apparatus achieving miniaturization while preventing optical surfaces of optical components from being damaged.

According to an embodiment of the invention, there is provided an optical imaging system including at least one optical component including an optical filter and a lens. In the optical imaging system, a hard coat is applied to an object side or an image side of an optical surface of the at least one optical component. In addition, the hard coat is formed to be able to come into contact with a different component positioned adjacent thereto or an optical surface of a different optical component positioned adjacent thereto.

Accordingly, in the optical imaging system, the optical surface of the optical component comes into contact with the different optical component or the different surface of the different optical component with the hard coat interposed therebetween.

In the above-mentioned optical imaging system, it is preferable that plural lens groups including an aperture stop and the lens should be arranged in a direction of an optical axis, and the hard coat should be applied to a lens of the lens group which is positioned to be closest to the aperture stop.

By applying the hard coat to the lens of the lens group positioned to be closest to the aperture stop, the hard coat is provided near the position at which the light flux diameter of rays becomes the maximum.

In the above-mentioned optical imaging system, it is preferable that plural lens groups, which include the lens and of which at least one is movable in a direction of an optical axis so as to change a focal length of the optical system, should be arranged. It is also preferable that a lens barrel having the plural lens groups arranged therein should be formed to be movable between an accommodated position, at which the lens barrel is accommodated in a camera main body, and an extended position to which the lens barrel is projected from the camera main body. In addition, it is also preferable that, at the accommodated position, the hard coat should come into contact with the different component positioned adjacent thereto or the optical surface of the different optical component positioned adjacent thereto.

By making the hard coat come into contact with the optical surface of the different optical component positioned adjacent thereto or the different component positioned adjacent thereto at the accommodated position, it is possible to decrease the clearance between the optical components or between the optical component and the different component at the accommodated position.

In the above-mentioned optical imaging system, it is preferable that plural lens groups, which include the lens and of which at least one is movable in a direction of an optical axis so as to change a focal length of the optical system, should be arranged. It is also preferable that a lens barrel having the plural lens groups arranged therein should be formed to be movable between an accommodated position, at which the lens barrel is accommodated in a camera main body, and an extended position to which the lens barrel is projected from the camera main body. In addition, it is also preferable that, at the extended position, the hard coat should come into contact with the different component positioned adjacent thereto or the optical surface of the different optical component positioned adjacent thereto.

By making the hard coat come into contact with the optical surface of the different optical component positioned adjacent thereto or the different component positioned adjacent thereto at the extended position, it is possible to decrease the clearance between the optical components or between the optical component and the different component at the extended position.

In the above-mentioned optical imaging system, it is preferable that plural lens groups, which include the lens and of which at least one is movable in a direction of an optical axis so as to change a focal length of the optical system, should be arranged. It is also preferable that, in two of the lens groups positioned adjacent to each other in the direction of the optical axis, the hard coats should be respectively applied to an optical surface, which is closest to the image side in the lens group positioned on the object side, and an optical surface, which is closest to the object side in the lens group positioned on the image side. It is also preferable that a lens barrel having the plural lens groups arranged therein should be formed to be movable between an accommodated position, at which the lens barrel is accommodated in a camera main body, and an extended position to which the lens barrel is projected from the camera main body. In addition, it is also preferable that, at the accommodated position, the hard coats should come into contact with each other.

By making the hard coats come into contact with each other at the accommodated position, it is possible to decrease the clearance between the optical components or between the optical component and the different component, and it is also possible to increase the movement stroke of the lens group necessary during zooming.

In the above-mentioned optical imaging system, it is preferable that plural lens groups, which include the lens and of which at least one is movable in a direction of an optical axis so as to change a focal length of the optical system, should be arranged. It is also preferable that, in two of the lens groups positioned adjacent to each other in the direction of the optical axis, the hard coats should be respectively applied to an optical surface, which is closest to the image side in the lens group positioned on the object side, and an optical surface, which is closest to the object side in the lens group positioned on the image side. It is also preferable that a lens barrel having the plural lens groups arranged therein should be formed to be movable between an accommodated position, at which the lens barrel is accommodated in a camera main body, and an extended position to which the lens barrel is projected from the camera main body. In addition, it is also preferable that, at the extended position, the hard coats should come into contact with each other.

By making the hard coats come into contact with each other at the extended position, it is possible to decrease the clearance between the optical components or between the optical component and the different component, and it is also possible to increase the movement stroke of the lens group necessary during zooming.

In the above-mentioned optical imaging system, it is preferable that the hard coat should satisfy the following conditional expression (1).

(1−Tc)×(Dc/Dfno)²<0.05, (1)

Here, Tc is a total light transmittance of visible light (a wavelength of 400 nm to 700 nm) through the hard coat, and (Dc/Dfno)² is a value of (an area of the hard coat)/(an area of an effective region of rays based on the F number) on the optical surface to which the hard coat is applied.

By making the optical imaging system satisfy the conditional expression (1), the transmittance of the hard coat and the area of the hard coat relative to the area of the effective region of the rays based on the F number are set to be appropriate.

In the above-mentioned optical imaging system, it is preferable that the hard coat should satisfy the following conditional expression (2).

(1−Tc)×(Dc/Dfno)²<0.03 (2)

Here, Tc is a total light transmittance of visible light (the wavelength of 400 nm to 700 nm) through the hard coat, and (Dc/Dfno)² is a value of (the area of the hard coat)/(the area of the effective region of rays based on the F number) on the optical surface to which the hard coat is applied.

By making the optical imaging system satisfy the conditional expression (2), the transmittance of the hard coat and the area of the hard coat relative to the area of the effective region of the rays based on the F number are set to be further appropriate.

In the above-mentioned optical imaging system, it is preferable that the hard coat should satisfy the following conditional expressions (3) and (4).

Tc>0.5 (3)

(Dc/Dfno)²<0.15

Here, Tc is a total light transmittance of visible light (the wavelength of 400 nm to 700 nm) through the hard coat, and (Dc/Dfno)² is a value of (the area of the hard coat)/(the area of the effective region of rays based on the F number) on the optical surface to which the hard coat is applied.

By making the optical imaging system satisfy the conditional expressions (3) and (4), the transmittance of the hard coat and the area of the hard coat relative to the area of the effective region of the rays based on the F number are set to be appropriate.

In the above-mentioned optical imaging system, it is preferable that the hard coat should satisfy the following conditional expressions (5) and (6).

Tc>0.7 (5)

(Dc/Dfno)²<0.1 (6)

Here, Tc is a total light transmittance of visible light (the wavelength of 400 nm to 700 nm) through the hard coat, and (Dc/Dfno)² is a value of (the area of the hard coat)/(the area of the effective region of rays based on the F number) on the optical surface to which the hard coat is applied.

By making the optical imaging system satisfy the conditional expressions (5) and (6), the transmittance of the hard coat and the area of the hard coat relative to the area of the effective region of the rays based on the F number are set to be further appropriate.

In the above-mentioned optical imaging system, it is preferable that the hard coat should satisfy the following conditional expression (7).

$${\sum }_{S = 1}^{n} \{ ( 1 - Tc , s ) \times {( Dc , s / Dfno , s )}^{2} \} < 0.2 \qquad ( 7 )$$

Here, n is the number of the optical surfaces to which the hard coats are applied in the optical system, (Tc, s) is a total light transmittance of visible light (the wavelength of 400 nm to 700 nm) through an S-th hard coat from the object side, and (Dc, s/Dfno, s)² is a value of (the area of the hard coat)/(the area of the effective region of rays based on the F number) on the optical surface to which the S-th hard coat from the object side is applied.

By making the optical imaging system satisfy the conditional expression (7), the transmittance of the hard coat and the area of the hard coat relative to the area of the effective region of the rays based on the F number are set to be appropriate.

In the above-mentioned optical imaging system, it is preferable that the hard coat should be formed in a circular shape centered on an optical axis of the optical component.

By forming the hard coat in the circular shape centered on the optical axis of the optical component, even when deviation occurs at the contact point of the hard coat, the hard coat easily comes into contact with the optical surface of the different optical component positioned adjacent thereto or the different component positioned adjacent thereto.

In the above-mentioned optical imaging system, it is preferable that a coat including diamond-like carbon should be used as the hard coat.

By using the coat including the diamond-like carbon as the hard coat, abrasion resistance of the hard coat increases, and thus in terms of preventing scratches, it exhibits excellent performance.

In the above-mentioned optical imaging system, it is preferable that a coat including a silicon nitride film should be used as the hard coat.

By using the coat including the silicon nitride film as the hard coat, abrasion resistance of the hard coat increases, and thus in terms of preventing scratches, it exhibits excellent performance.

According to another embodiment of the invention, there is provided an imaging apparatus including: an optical imaging system; and an imaging device that converts an optical image, which is formed by the optical imaging system, into an electric signal. The optical imaging system has at least one optical component including an optical filter and a lens. In the optical imaging system, a hard coat is applied to an object side or an image side of an optical surface of the at least one optical component. In addition, the hard coat is formed to be able to come into contact with a different component positioned adjacent thereto or an optical surface of a different optical component positioned adjacent thereto.

Accordingly, in the imaging apparatus, the optical surface of the optical component comes into contact with the different component or the different optical surface of the different optical component with the hard coat interposed therebetween.

The optical imaging system and the imaging apparatus according to the embodiments of the invention are able to achieve miniaturization while preventing the optical surfaces of the optical components from being damaged.

### BRIEF DESCRIPTION OF THE DRAWINGS

FIG. 1 is a schematic diagram illustrating a relationship among the outer diameter of a lens, the effective diameter of rays based on an F number on the hard coated optical surface, and the diameter of the hard coat.

FIG. 2 is a diagram illustrating an optical imaging system according to a first embodiment together with FIG. 3, and is a diagram illustrating an extended position state of the system.

FIG. 3 is a diagram illustrating an accommodated position state of the system.

FIG. 4 is a diagram illustrating an optical imaging system according to a second embodiment together with FIG. 5, and is a diagram illustrating an extended position state of the system.

FIG. 5 is a diagram illustrating an accommodated position state of the system.

FIG. 6 is a diagram illustrating an optical imaging system according to a third embodiment together with FIG. 7, and is a diagram illustrating an extended position state of the system at the wide-angle end.

FIG. 7 is a diagram illustrating an extended position state of the system at the telephoto end.

FIG. 8 is a block diagram illustrating an imaging apparatus according to an embodiment.

### DESCRIPTION OF THE PREFERRED EMBODIMENTS

Hereinafter, optical imaging systems and imaging apparatuses according to the preferred embodiments of the invention will be described.

### Configuration of Optical Imaging System

An optical imaging system according to an embodiment of the invention has at least one optical component including an optical filter and a lens. In the system, a hard coat is applied to the object side or the image side of an optical surface of the at least one optical component. The hard coat is formed to be able to come into contact with a different component positioned adjacent thereto or an optical surface of a different optical component positioned adjacent thereto.

Examples of the optical component include not only the above-mentioned lens and optical filter, but also include, for example, a cover lid of the imaging device and the like.

Further, examples of the different component include, for example, the respective portions constituting an exterior casing of the lens barrel which has a lens barrier, an aperture stop, a shutter, lenses, and the like arranged therein.

The hard coat is a coating layer (a thin film) which is applied to the surface of the component and the product in order to prevent it from being damaged and being contaminated.

With such a configuration of the optical imaging system, when the optical components or the optical component and the different component become close to each other, the hard coat comes into contact with the optical surface thereof or the different component. Hence, it is possible to prevent the optical surface of the optical component from being damaged, and thus it is possible to achieve miniaturization of the system while preventing the optical surface of the optical component from being damaged.

In the optical imaging system according to the embodiment of the invention, it is preferable that plural lens groups including an aperture stop and the lens should be arranged in a direction of an optical axis, and the hard coat should be applied to a lens of the lens group which is positioned to be closest to the aperture stop.

In the optical imaging system, it is necessary to set the light flux diameter so as to maximize the light amount of the rays passing through the position of the aperture stop (so as to maximize the distance between the principal ray and the upper and lower peripheral rays). Hence, the hard coat is applied to the lens of the lens group positioned to be closest to the aperture stop. In such a manner, it is possible to minimize non-uniformity in the illuminance on the image plane caused by the hard coat.

In the optical imaging system according to the embodiment of the invention, it is preferable that the plural lens groups, which include the lens and of which at least one is movable in a direction of an optical axis so as to change the focal length of the optical system, should be arranged. It is also preferable that a lens barrel having the plural lens groups arranged therein should be formed to be movable between the accommodated position, at which the lens barrel is accommodated in the camera main body, and the extended position to which the lens barrel is projected from the camera main body. In addition, it is also preferable that, at the accommodated position, the hard coat should come into contact with the different component positioned adjacent thereto or the optical surface of the different optical component positioned adjacent thereto.

With such a configuration of the optical imaging system, at the accommodated position at which the lens groups are collapsed, it is possible to decrease the clearance between the optical components or between the optical component and the different component. Consequently, it is possible to make the optical imaging system thinner.

In the optical imaging system according to the embodiment of the invention, it is preferable that, at the extended position, the hard coat should come into contact with the different component positioned adjacent thereto or the optical surface of the different optical component positioned adjacent thereto.

That is, in the case of using the optical imaging system and the imaging apparatus having the same at the time of extending the lens barrel, it is preferable that the hard coat should come into contact with the optical surface of the different optical component positioned adjacent thereto or the different component positioned adjacent thereto.

With such a configuration of the optical imaging system, at the extended position to which the lens groups are extended, it is possible to decrease the clearance between the optical components or between the optical component and the different component. Consequently, it is possible to make the optical imaging system thinner.

In the optical imaging system according to the embodiment of the invention, it is preferable that, in two of the lens groups positioned adjacent to each other in the direction of the optical axis, the hard coats should be respectively applied to the optical surface, which is closest to the image side in the lens group positioned on the object side, and the optical surface, which is closest to the object side in the lens group positioned on the image side. It is also preferable that the lens barrel should be formed to be movable between the accommodated position and the extended position. In addition, it is also preferable that, at the accommodated position, the hard coats should come into contact with each other.

With such a configuration of the optical imaging system, at the accommodated position at which the lens groups are collapsed, it is possible to decrease the clearance between the optical components or between the optical component and the different component. Consequently, it is possible to miniaturize the optical imaging system.

Further, for example, by making the hard coats of the lens group closest to each other in the wide-angle end and telephoto end state of the optical imaging system come into contact with each other, it is possible to increase the movement stroke of the lens group necessary for zooming. Accordingly, it is possible to achieve an increase in magnification while securing miniaturization of the optical imaging system. Further, it is possible to achieve miniaturization thereof without changing the magnification.

Moreover, by adopting the configuration in which the hard coats come into contact with each other, it is possible to reliably prevent the respective hard-coated optical surfaces from being damaged.

In the optical imaging system according to the embodiment of the invention, it is preferable that, in two of the lens groups positioned adjacent to each other in the direction of the optical axis, the hard coats should be respectively applied to the optical surface, which is closest to the image side in the lens group positioned on the object side, and the optical surface, which is closest to the object side in the lens group positioned on the image side. It is also preferable that the lens barrel should be formed to be movable between the accommodated position and the extended position. In addition, it is also preferable that, at the extended position, the hard coats should come into contact with each other.

With such a configuration of the optical imaging system, at the extended position to which the lens groups are extended, it is possible to decrease the clearance between the optical components or between the optical component and the different component. Consequently, it is possible to miniaturize the optical imaging system.

Further, for example, by making the hard coats of the lens group closest to each other in the wide-angle end and telephoto end state of the optical imaging system come into contact with each other, it is possible to increase the movement stroke of the lens group necessary for zooming. Accordingly, it is possible to achieve an increase in magnification while securing miniaturization of the optical imaging system. Further, it is possible to achieve miniaturization thereof without changing the magnification.

Moreover, by adopting the configuration in which the hard coats come into contact with each other, it is possible to reliably prevent the respective hard-coated optical surfaces from being damaged.

In the optical imaging system according to the embodiment of the invention, it is preferable that the hard coat should satisfy the following conditional expression (1).

(1−Tc)×(Dc/Dfno)²<0.05 (1)

Here, Tc is a total light transmittance of visible light (a wavelength of 400 nm to 700 nm) through the hard coat, and (Dc/Dfno)² is a value of (an area of the hard coat)/(an area of an effective region of rays based on the F number) on the optical surface to which the hard coat is applied.

The conditional expression (1) defines the transmittance of the hard coat applied to the optical surface and the area of the hard coat on the optical surface.

When the result of the conditional expression (1) exceeds the upper limit thereof, the transmittance of the hard coat becomes too low, or the area of the hard coat becomes too large. For this reason, there are concerns that the illuminance of the image formed by the optical system becomes too low and non-uniformity in the light amount and the reflection of a part of or the entirety of the hard coat occurs in a part of the image.

Accordingly, by making the optical imaging system satisfy the conditional expression (1), it is possible to secure the illuminance suitable for the image formed by the optical system. Further, it is possible to prevent non-uniformity in the light amount and the reflection of the hard coat from occurring in a part of the image.

Further, it is more preferable that the optical imaging system should satisfy the following conditional expression (2).

(1−Tc)×(Dc/Dfno)²<0.03 (2)

Here, the definitions of the respective signs of the conditional expression (2) are the same as those of the conditional expression (1).

By making the optical imaging system satisfy the conditional expression (2), it is possible to secure the illuminance further enough for the image formed by the optical system. Further, it is possible to reliably prevent non-uniformity in the light amount and the reflection of the hard coat from occurring in a part of the image.

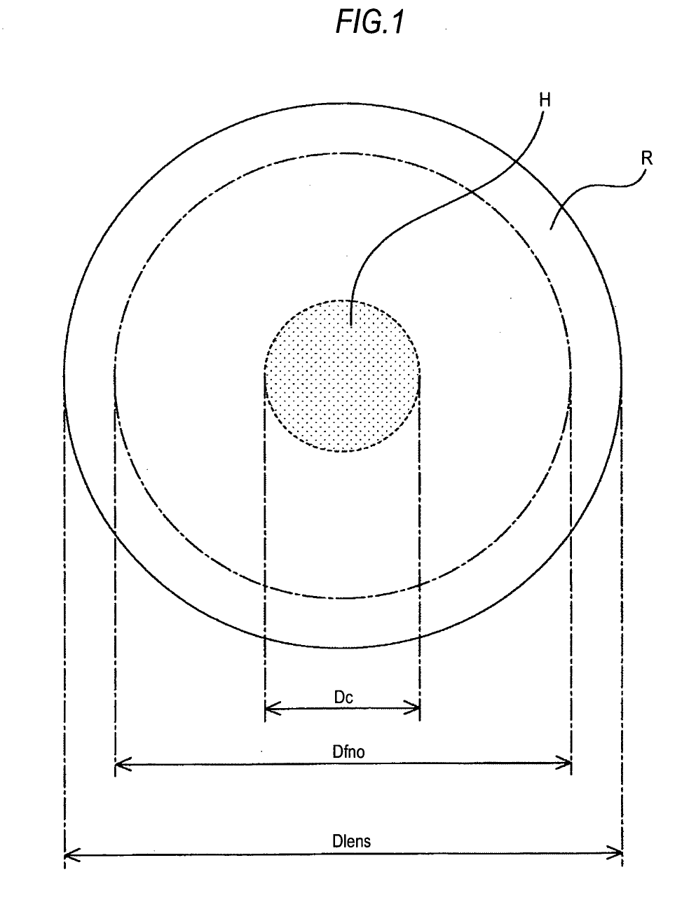

In particular, when the hard coat is formed in a circular shape centered on the optical axis of the optical component, in the conditional expressions (1) and (2), Dc is a diameter of the hard coat, and Dfno is an effective diameter of the rays based on the F number on the hard-coated optical surface. For example, as shown in FIG. 1, the hard coat H is applied with a size of the diameter Dc to the center portion of the lens R. Assuming the outer diameter of the lens is Dlens, the effective diameter Dfno of the rays based on the F number is present therein, and the hard coat H is present at the center portion.

In the optical imaging system according to the embodiment of the invention, it is preferable that the hard coat should satisfy the following conditional expressions (3) and (4).

Tc>0.5 (3)

(Dc/Dfno)²<0.15 (4)

Here, Tc is a total light transmittance of visible light (the wavelength of 400 nm to 700 nm) through the hard coat, and (Dc/Dfno)² is a value of (the area of the hard coat)/(the area of the effective region of rays based on the F number) on the optical surface to which the hard coat is applied.

The conditional expression (3) defines the transmittance of the hard coat, and the conditional expression (4) defines the area of the hard coat on the optical surface.

When the result of the conditional expression (3) exceeds the lower limit thereof and becomes too small, the transmittance of the hard coat becomes too low. When the result of the conditional expression (4) exceeds the upper limit thereof and becomes too large, the area of the hard coat on the optical surface becomes too large. Thus, there are concerns that the illuminance of the image formed by the optical system becomes too low and non-uniformity in the light amount and the reflection of a part of or the entirety of the hard coat occurs in a part of the image.

Accordingly, by making the optical imaging system satisfy the conditional expressions (3) and (4), it is possible to secure the illuminance suitable for the image formed by the optical system. Further, it is possible to prevent non-uniformity in the light amount and the reflection of the hard coat from occurring in a part of the image.

Further, it is more preferable that the optical imaging system should satisfy the following conditional expressions (5) and (6).

Tc>0.7 (5)

(Dc/Dfno)²<0.1 (6)

Here, the definitions of the respective signs of the conditional expressions (5) and (6) are the same as those of the conditional expressions (3) and (4).

By making the optical imaging system satisfy the conditional expressions (5) and (6), it is possible to secure the illuminance further enough for the image formed by the optical system. Further, it is possible to reliably prevent non-uniformity in the light amount and the reflection of the hard coat from occurring in a part of the image.

In particular, when the hard coat is formed in a circular shape centered on the optical axis of the optical component, in the conditional expressions (4) and (6), Dc is a diameter of the hard coat, and Dfno is an effective diameter of the rays based on the F number on the hard-coated optical surface.

In the optical imaging system according to the embodiment of the invention, it is preferable that the hard coat should satisfy the following conditional expression (7).

$${\sum }_{S = 1}^{n} \{ ( 1 - Tc , s ) \times {( Dc , s / Dfno , s )}^{2} \} < 0.2 \qquad ( 7 )$$

Here, n is the number of the optical surfaces to which the hard coats are applied in the optical system, (Tc, s) is a total light transmittance of visible light (the wavelength of 400 nm to 700 nm) through an S-th hard coat from the object side, and (Dc, s/Dfno, s)² is a value of (the area of the hard coat)/(the area of the effective region of rays based on the F number) on the optical surface to which the S-th hard coat from the object side is applied.

The conditional expression (7) defines the sum of the values of the conditional expression (1) for all the respective hard coats in the optical system.

When the result of the conditional expression (7) exceeds the upper limit thereof, the transmittance of the hard coat becomes too low, or the area of the hard coat becomes too large. For this reason, there are concerns that the illuminance of the image formed by the optical system becomes too low and non-uniformity in the light amount and the reflection of a part of or the entirety of the hard coat occur in a part of the image.

Accordingly, by making the optical imaging system satisfy the conditional expression (7), it is possible to secure the illuminance suitable for the image formed by the optical system. Further, it is possible to prevent non-uniformity in the light amount and the reflection of the hard coat from occurring in a part of the image.

In particular, when the hard coat is formed in a circular shape centered on the optical axis of the optical component, in the conditional expression (7), (Dc, s) is a diameter of the S-th hard coat from the object side, and (Dfno, s) is an effective diameter of the rays based on the F number on the optical surface to which the S-th hard coat from the object side is applied.

In the optical imaging system according to the embodiment of the invention, it is preferable that the hard coat should be formed in a circular shape centered on an optical axis of the optical component.

By forming the hard coat in the circular shape centered on the optical axis of the optical component, even when deviation is caused at the contact point of the hard coat by for example errors in precision of the assembly of the lens and the like to the lens holding frame and the like and precision of the processing of the optical components, it is possible to prevent the contact error, which is caused when the portion other than the hard coat comes into contact with the optical component, from occurring.

In the optical imaging system according to the embodiment of the invention, it is preferable that a coat including diamond-like carbon or a silicon nitride film (Si₃N₄) should be used as the hard coat.

The diamond-like carbon is an amorphous rigid film formed of carbon hydride or allotropes of carbon.

It is known that, since the diamond-like carbon and silicon nitride film has high abrasion resistance, in terms of preventing scratches, it also exhibits excellent performance. Accordingly, by using the coat including the diamond-like carbon or the silicon nitride film as the hard coat, it is possible to reliably prevent the optical surface from being damaged or the hard coat from abrading.

Further, it is known that it is technically possible for the coats using the diamond-like carbon and silicon nitride films to secure at least 50% or more of the transmittance at the wavelength of the visible light region even in the case of a single coat. Accordingly, by using the coat including the diamond-like carbon or the silicon nitride film as the hard coat, a high transmittance in the optical component such as a lens is secured, and thus it is possible to secure high performance in the optical imaging system.

Moreover, by forming the diamond-like carbon or silicon nitride film as a multilayer film together with a coating material such as silicon dioxide of which the refractive index is relatively low, it is possible to lower the reflectance of the coat and improve the transmittance thereof while maintaining the effects of the abrasion resistance and the prevention of scratches. Accordingly, by using the coat including the diamond-like carbon or silicon nitride film as the hard coat, it is possible to suppress deterioration in image quality of the optical imaging system.

In addition, the diamond-like carbon and silicon nitride film can be coated by using a deposition facility, of which general versatility is relatively high, such as a sputter. Hence, by using the coat including the diamond-like carbon or silicon nitride film as the hard coat, it is possible to reduce manufacturing costs.

### Specific Embodiments of Optical Imaging System

Hereinafter, optical imaging systems according to specific embodiments of the invention will be described with reference to the accompanying drawings.

### First Embodiment

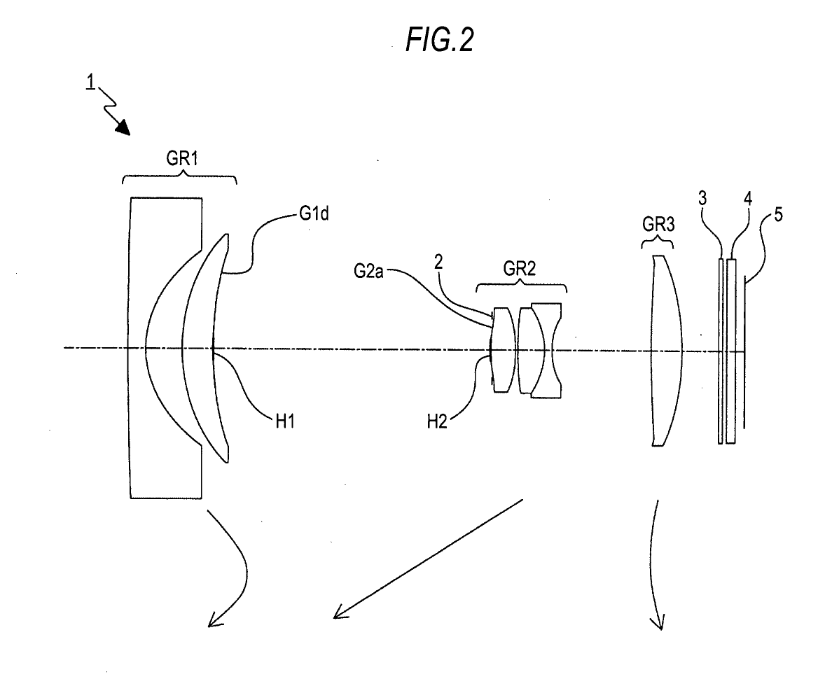

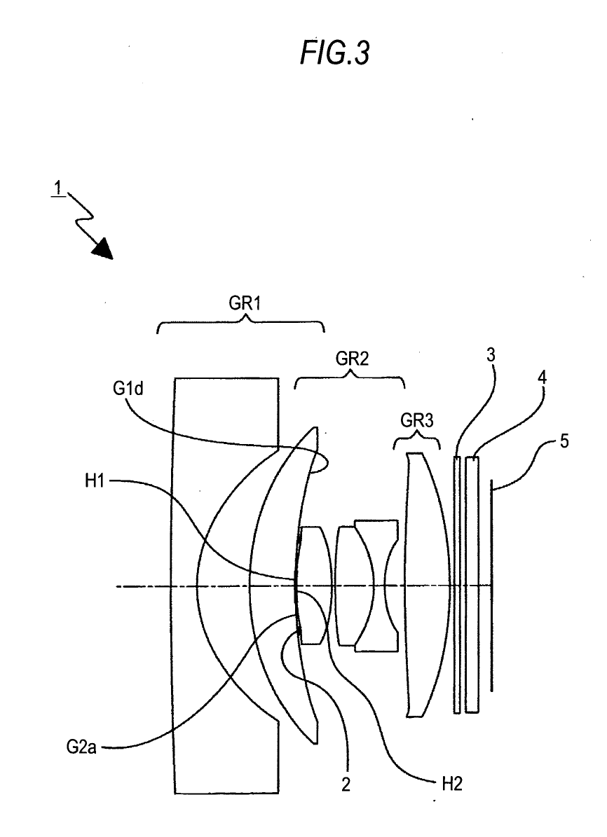

FIGS. 2 and 3 show a lens configuration of an optical imaging system 1 according to a first embodiment.

The optical imaging system 1 is formed to include, in order from the object side toward the image side, a first lens group GR1, an aperture stop 2, a second lens group GR2, a third lens group GR3, an optical filter 3, a slit glass (a cover lid) 4, and an imaging device 5.

The first lens group GR1, the second lens group GR2, and the third lens group GR3 are configured to be movable in the direction of the optical axis.

A hard coat H1 is applied to the center portion on the optical surface G1d closest to the image side in the first lens group GR1, and a hard coat H2 is applied to the center portion on the optical surface G2b closest to the object side in the second lens group GR2.

At the extended position to which the optical imaging system 1 is extended from a camera main body not shown in the drawing, the first lens group GR1 and the second lens group GR2 are separated by a predetermined distance in the direction of the optical axis (refer to FIG. 2). The extended position is a position at the time of using the imaging apparatus having the optical imaging system 1, for example, at the time of photography.

At the accommodated position at which the optical imaging system 1 is accommodated in the camera main body, the hard coat H1 applied to the first lens group GR1 and the hard coat H2 applied to the second lens group GR2 are in contact with each other. That is, the first lens group GR1 and the second lens group GR2 are in contact with each other with the hard coats H1 and H2 interposed therebetween (refer to FIG. 3). The accommodated position is, for example, position at the time of not using the imaging apparatus having the optical imaging system 1.

As described above, by making the first lens group GR1 and the second lens group GR2 come into contact with each other with the hard coats H1 and H2 interposed therebetween, it is possible to achieve miniaturization of the optical imaging system 1 and the imaging apparatus having the system while preventing the respective lenses of the first lens group GR1 and the second lens group GR2 from being damaged at the accommodated position.

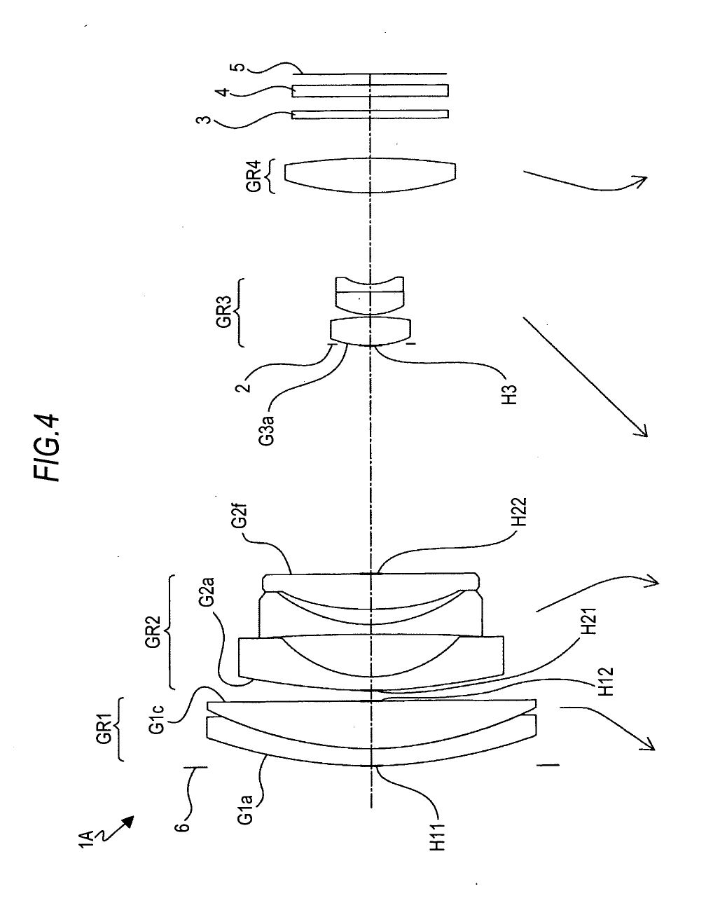

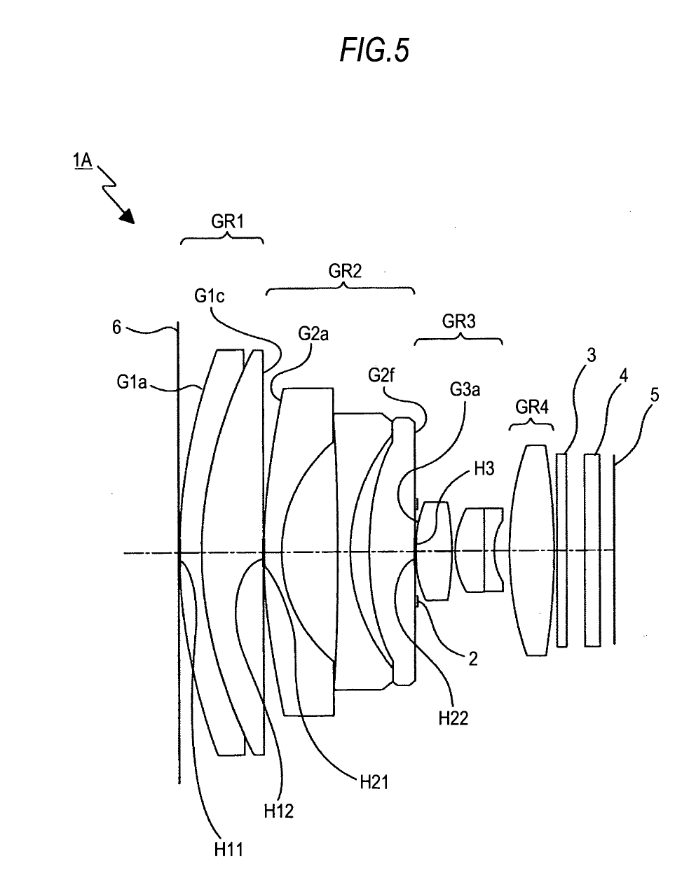

FIGS. 4 and 5 show a lens configuration of the optical imaging system 1A according to a second embodiment.

The optical imaging system 1A is formed to include, in order from the object side toward the image side, a first lens group GR1, a second lens group GR2, an aperture stop 2, a third lens group GR3, an optical filter 3, a slit glass (a cover lid) 4, and an imaging device 5.

The first lens group GR1, the second lens group GR2, the third lens group GR3, and the fourth lens group GR4 are configured to be movable in the direction of the optical axis.

A hard coat H11 is applied to the center portion on the optical surface G1a closest to the object side in the first lens group GR1. A hard coat H12 is applied to the center portion on the optical surface G1c closest to the image side in the first lens group GR1. A hard coat H21 is applied to the center portion on the optical surface G2a closest to the object side in the second lens group GR2. A hard coat H22 is applied to the center portion on the optical surface G2f closest to the image side in the second lens group GR2. A hard coat H3 is applied to the center portion on the optical surface G3a closest to the object side in the third lens group GR3.

At the position closest to the object side of the optical imaging system 1A, a lens barrier 6 for opening and closing the optical path is disposed.

At the extended position to which the optical imaging system 1A is extended from the camera main body not shown in the drawing, the first lens group GR1 and the second lens group GR2 are separated by a predetermined distance in the direction of the optical axis, and the second lens group GR2 and the third lens group GR3 are separated by a predetermined distance in the direction of the optical axis (refer to FIG. 4). The extended position is a position at the time of using the imaging apparatus having the optical imaging system 1A, for example, at the time of photography.

At this time, the lens barrier 6 is open.

At the accommodated position at which the optical imaging system 1A is accommodated in the camera main body, the hard coat H12 applied to the first lens group GR1 and the hard coat H21 applied to the second lens group GR2 are in contact with each other, and the hard coat H22 applied to the second lens group GR2 and the hard coat H3 applied to the third lens group GR3 are in contact with each other (refer to FIG. 5). Accordingly, the first lens group GR1 and the second lens group GR2 are in contact with each other with the hard coats H12 and H21 interposed therebetween, and the second lens group GR2 and the third lens group GR3 are in contact with each other with the hard coats H22 and H3 interposed therebetween. The accommodated position is, for example, a position at the time of not using the imaging apparatus having the optical imaging system 1A.

At this time, the lens barrier 6 is closed, and the hard coat H11 applied to the first lens group GR1 is in contact with the lens barrier 6.

As described above, the first lens group GR1 and the second lens group GR2 are configured to come into contact with each other with the hard coats H12 and H21 interposed therebetween, and the second lens group GR2 and the third lens group GR3 are configured to come into contact with each other with the hard coats H22 and H3 interposed therebetween. With such configurations, it is possible to achieve miniaturization of the optical imaging system 1A and the imaging apparatus having the system while preventing the respective lenses of the first lens group GR1, the second lens group GR2, and the third lens group GR3 from being damaged at the accommodated position.

Further, by making the first lens group GR1 and the lens barrier 6 come into contact with each other with the hard coat H11 interposed therebetween, it is possible to achieve miniaturization of the optical imaging system 1A and the imaging apparatus having the system while preventing the lens of the first lens group GR1 from being damaged.

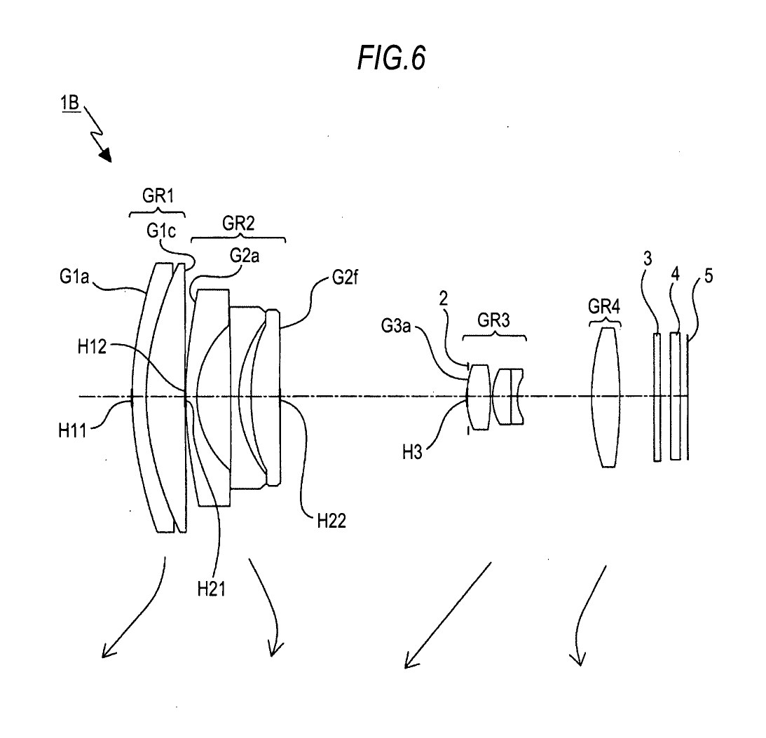

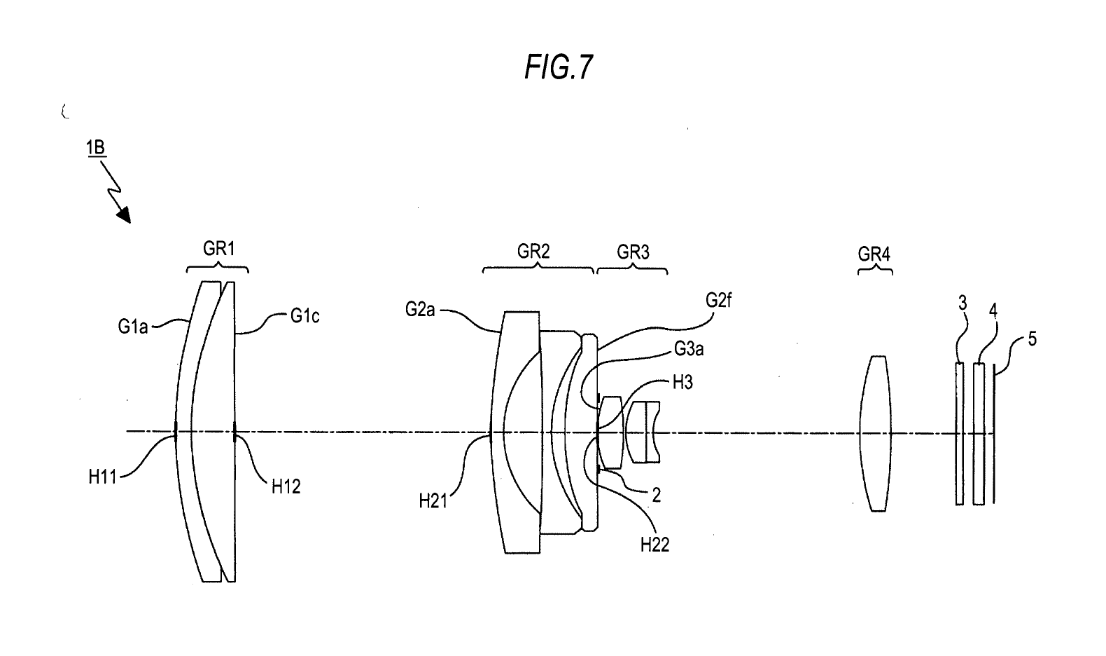

FIGS. 6 and 7 show a lens configuration of the optical imaging system 1B according to a third embodiment.

The optical imaging system 1B is formed to include, in order from the object side toward the image side, a first lens group GR1, a second lens group GR2, an aperture stop 2, a third lens group GR3, a fourth lens group GR4, an optical filter 3, a slit glass (a cover lid) 4, and an imaging device 5.

The first lens group GR1, the second lens group GR2, the third lens group GR3, and the fourth lens group GR4 are configured to be movable in the direction of the optical axis.

A hard coat H1 is applied to the center portion on the optical surface G1c closest to the image side in the first lens group GR1. A hard coat H21 is applied to the center portion on the optical surface G2a closest to the object side in the second lens group GR2. A hard coat H22 is applied to the center portion on the optical surface G2f closest to the image side in the second lens group GR2. A hard coat H3 is applied to the center portion on the optical surface G3a closest to the object side in the third lens group GR3.

In the wide-angle end state at the extended position to which the optical imaging system 1B is extended from the camera main body not shown in the drawing, the hard coat H1 applied to the first lens group GR1 and the hard coat H21 applied to the second lens group GR2 are in contact with each other, and the second lens group GR2 and the third lens group GR3 are separated by a predetermined distance in the direction of the optical axis (refer to FIG. 6). Accordingly, the first lens group GR1 and the second lens group GR2 are in contact with each other with the hard coats H1 and H21 interposed therebetween. The extended position is a position at the time of using the imaging apparatus having the optical imaging system 1B, for example, at the time of photography.

In the telephoto end state at the extended position of the optical imaging system 1B, the first lens group GR1 and the second lens group GR2 are separated by a predetermined distance in the direction of the optical axis, the hard coat H22 applied to the second lens group GR2 and the hard coat H3 applied to the third lens group GR3 are in contact with each other (refer to FIG. 7). Accordingly, the second lens group GR2 and the third lens group GR3 are in contact with each other with the hard coats H22 and H3 interposed therebetween.

As described above, the first lens group GR1 and the second lens group GR2 are configured to come into contact with each other with the hard coats H1 and H21 interposed therebetween. With such a configuration, when the optical imaging system 1B at the extended position is in the wide-angle end state, it is possible to achieve miniaturization of the optical imaging system 1B and the imaging apparatus having the system while preventing the respective lenses of the first lens group GR1 and the second lens group GR2 from being damaged.

Further, as described above, the second lens group GR2 and the third lens group GR3 are configured to come into contact with each other with the hard coats H22 and H3 interposed therebetween. With such a configuration, it is possible to achieve miniaturization of the optical imaging system 1B and the imaging apparatus having the system while preventing the respective lenses of the second lens group GR2 and the third lens group GR3 from being damaged at the extended position.

### Configuration of Imaging Apparatus

In an imaging apparatus according to an embodiment of the invention, the optical imaging system has at least one optical component including the optical filter and the lens. In the system, the hard coat is applied to the object side or the image side of the optical surface of the at least one optical component. The hard coat is formed to be able to come into contact with the different component positioned adjacent thereto or the optical surface of the different optical component positioned adjacent thereto.

Examples of the optical component include not only the above-mentioned lens and optical filter, but also include, for example, a cover lid of the imaging device and the like.

Further, examples of the different component include, for example, the respective portions constituting an exterior casing of the lens barrel which has a lens barrier, an aperture stop, a shutter, lenses, and the like arranged therein.

The hard coat is a coating layer (a thin film) which is applied to the surface of the component and the product in order to prevent them from being damaged and being contaminated.

With such a configuration of the optical imaging system of the imaging apparatus, when the optical components or the optical component and the different component become close to each other, the hard coat comes into contact with the optical surface thereof or the different component. Hence, it is possible to prevent the optical surface of the optical component from being damaged, and thus it is possible to achieve miniaturization of the system while preventing the optical surface of the optical component from being damaged.

### Embodiment of Imaging Apparatus

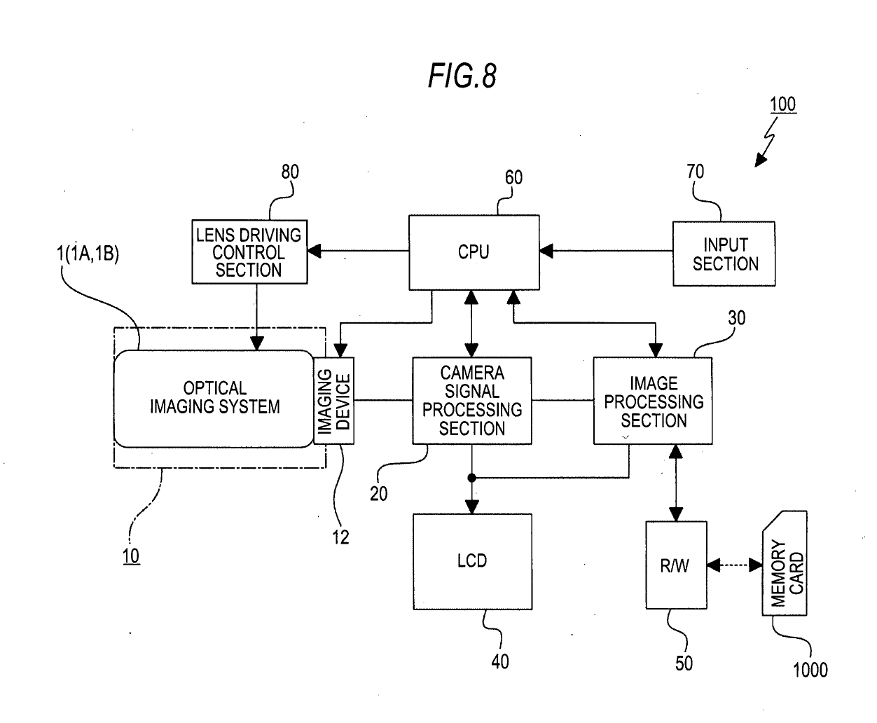

FIG. 8 shows a block diagram of a digital still camera of the imaging apparatus according to the embodiment of the invention.

The imaging apparatus (the digital still camera) 100 includes: a camera block 10 that has a function of taking an image; a camera signal processing section 20 that performs a signal processing such as an analog-to-digital conversion processing on a taken image signal; an image processing section 30 that performs a process of recording and reproducing the image signal. Further, the imaging apparatus 100 includes: an LCD (Liquid Crystal Display) 40 that displays the taken image and the like; a R/W (reader/writer) 50 that writes and reads image signals in the memory card 1000; a CPU (Central Processing Unit) 60 that controls the entire imaging apparatus; an input section 70, such as various switches, that is used for user operation input; and a lens driving control section 80 that controls driving of the lens within the camera block 10.

The camera block 10 includes: an optical system (the optical imaging system 1, 1A, or 1B according to the embodiment of the invention) including the zoom lens 11; and an imaging device 12 including, for example, a CCD (Charge Coupled Device) sensor, a CMOS (Complementary Metal Oxide Semiconductor) sensor or the like.

The camera signal processing section 20 is configured to perform various signal processes, such as a process of conversion into a digital signal, noise removal, image quality correction, and a process of conversion into luminance and chromatic difference signals, on the output signal which is output from the imaging device 12.

The image processing section 30 is configured to perform a process of encoding for compression and decoding for decompression on an image signal based on a predetermined image data format, a process of conversion of data specification such as resolution, and the like.

The LCD 40 has a function to display various data such as a condition of the operation performed by a user with the aid of the input section 70 and a taken image.

The R/W 50 is configured to write image data, which is encoded by the image processing section 30, into the memory card 1000 and additionally read the image data which is recorded on the memory card 1000.

The CPU 60 functions as a control processing section to control all the circuit blocks within the imaging apparatus 100, and controls the circuit blocks on the basis of the instruction input signals and the like from the input section 70.

The input section 70 includes, for example, a shutter release button for performing a shutter operation, a selection switch for selecting operation modes, and the like. The input section 70 is configured to output the instruction input signal in response to the user operation to the CPU 60.

The lens driving control section 80 is configured to control a motor, which is not shown in the drawing, for driving the lenses within the zoom lens 11 on the basis of the control signal from the CPU 60.

The memory card 1000 is, for example, a semiconductor memory which is removable from a slot connected to the R/W 50.

Next, operations of the imaging apparatus 100 will be described.

When the photographing is in standby, an image signal captured by the camera block 10 under the control of the CPU 60 is output to the LCD 40 through the camera signal processing section 20 so as to be displayed as a camera-through-image. Further, when the instruction input signal for zooming is input from the input section 70, the CPU 60 outputs a control signal to the lens driving control section 80, and moves predetermined lenses within the zoom lens 11 on the basis of the control of the lens driving control section 80.

When the not-shown shutter of the camera block 10 is operated by the instruction input signal from the input section 70, the captured image signal is output from the camera signal processing section 20 to the image processing section 30, is encoded for compression, and is converted into digital data of the predetermined data format. The converted data is output to the R/W 50 and is written in the memory card 1000.

For focusing, the lens driving control section 80 moves the predetermined lenses of the zoom lens 11 on the basis of the control signal received from the CPU 60, for example, when the shutter release button of the input section 70 is pressed halfway or pressed fully for recording (photography).

For reproduction of image data recorded in the memory card 1000, the R/W 50 reads out the prescribed image data from the memory card 1000 in response to the operation performed on the input section 70. The readout image data is decoded for decompression by the image processing section 30 and the reproduced image signal is then output to the LCD 40, thereby displaying the reproduced image.

In addition, the embodiment has described the case where the imaging apparatus according to the embodiment of the invention is applied to a digital camera. However, the application range of the imaging apparatus is not limited to a digital still camera, and it may also be widely applied to, for example, camera sections of digital input/output apparatuses such as a digital video camera, a mobile phone equipped with a camera, and a PDA (Personal Digital Assistant) equipped with a camera.

The shapes of components and the numerical values described or shown in the above-mentioned embodiments are only illustrative examples of the embodiments for implementing the invention, and they should not be interpreted as limiting the technical scope of the invention.

The present application contains subject matter related to that disclosed in Japanese Priority Patent Application JP 2010-069464 filed in the Japan Patent Office on Mar. 25, 2010, the entire contents of which is hereby incorporated by reference.

What is claimed is:

1. An optical imaging system comprising:
at least one optical component including an optical filter and a lens,
wherein a hard coat is applied to an object side or an image side of an optical surface of the at least one optical component, and
the hard coat is formed to be able to come into contact with a different component positioned adjacent thereto or an optical surface of a different optical component positioned adjacent thereto.

2. The optical imaging system according to claim 1,
wherein a plurality of lens groups including an aperture stop and the lens are arranged in a direction of an optical axis, and
the hard coat is applied to a lens of the lens group which is positioned to be closest to the aperture stop.

3. The optical imaging system according to claim 1,
wherein a plurality of lens groups, which include the lens and of which at least one is movable in a direction of an optical axis so as to change a focal length of the optical system, are arranged,
a lens barrel having the plurality of lens groups arranged therein is formed to be movable between an accommodated position, at which the lens barrel is accommodated in a camera main body, and an extended position, to which the lens barrel is projected from the camera main body, and
at the accommodated position, the hard coat comes into contact with the different component positioned adjacent thereto or the optical surface of the different optical component positioned adjacent thereto.

4. The optical imaging system according to claim 1,
wherein a plurality of lens groups, which include the lens and of which at least one is movable in a direction of an optical axis so as to change a focal length of the optical system, are arranged,
a lens barrel having the plurality of lens groups arranged therein is formed to be movable between an accommodated position, at which the lens barrel is accommodated in a camera main body, and an extended position, to which the lens barrel is projected from the camera main body, and
at the extended position, the hard coat comes into contact with the different component positioned adjacent thereto or the optical surface of the different optical component positioned adjacent thereto.

5. The optical imaging system according to claim 1,
wherein a plurality of lens groups, which include the lens and of which at least one is movable in a direction of an optical axis so as to change a focal length of the optical system, are arranged,
in two of the lens groups positioned adjacent to each other in the direction of the optical axis, the hard coats are respectively applied to an optical surface, which is closest to the image side in the lens group positioned on the object side, and an optical surface, which is closest to the object side in the lens group positioned on the image side,
a lens barrel having the plurality of lens groups arranged therein is formed to be movable between an accommodated position, at which the lens barrel is accommodated in a camera main body, and an extended position, to which the lens barrel is projected from the camera main body, and
at the accommodated position, the hard coats come into contact with each other.

6. The optical imaging system according to claim 1,
wherein a plurality of lens groups, which include the lens and of which at least one is movable in a direction of an optical axis so as to change a focal length of the optical system, are arranged,
in two of the lens groups positioned adjacent to each other in the direction of the optical axis, the hard coats are respectively applied to an optical surface, which is closest to the image side in the lens group positioned on the object side, and an optical surface, which is closest to the object side in the lens group positioned on the image side,
a lens barrel having the plurality of lens groups arranged therein is formed to be movable between an accommodated position, at which the lens barrel is accommodated in a camera main body, and an extended position, to which the lens barrel is projected from the camera main body, and
at the extended position, the hard coats come into contact with each other.

7. The optical imaging system according to claim 1, wherein the hard coat satisfies the following conditional expression (1)
(1−Tc)×(Dc/Dfno)²<0.05, (1)
where
Tc is a total light transmittance of visible light (a wavelength of 400 nm to 700 nm) through the hard coat, and
(Dc/Dfno)² is a value of (an area of the hard coat)/(an area of an effective region of rays based on an F number) on the optical surface to which the hard coat is applied.

8. The optical imaging system according to claim 1, wherein the hard coat satisfies the following conditional expression (2)
(1−Tc)×(Dc/Dfno)²<0.03, (2)
where
Tc is a total light transmittance of visible light (a wavelength of 400 nm to 700 nm) through the hard coat, and
(Dc/Dfno)² is a value of (an area of the hard coat)/(an area of an effective region of rays based on an F number) on the optical surface to which the hard coat is applied.

9. The optical imaging system according to claim 1, wherein the hard coat satisfies the following conditional expressions (3) and (4)
Tc>0.5 (3)
(Dc/Dfno)²<0.15 (4)
where
Tc is a total light transmittance of visible light (a wavelength of 400 nm to 700 nm) through the hard coat, and
(Dc/Dfno)² is a value of (an area of the hard coat)/(an area of an effective region of rays based on an F number) on the optical surface to which the hard coat is applied.

10. The optical imaging system according to claim 1, wherein the hard coat satisfies the following conditional expressions (5) and (6)
Tc>0.7 (5)
(Dc/Dfno)²<0.1 (6)
where
Tc is a total light transmittance of visible light (a wavelength of 400 nm to 700 nm) through the hard coat, and
(Dc/Dfno)² is a value of (an area of the hard coat)/(an area of an effective region of rays based on an F number) on the optical surface to which the hard coat is applied.

11. The optical imaging system according to claim 1, wherein the hard coat satisfies the following conditional expression (7)
$${\sum }_{S = 1}^{n} \{ ( 1 - Tc , s ) \times {( Dc , s / Dfno , s )}^{2} \} < 0.2 , \qquad ( 7 )$$
where
n is the number of the optical surfaces to which the hard coats are applied in the optical system,
Tc, s is a total light transmittance of visible light (a wavelength of 400 nm to 700 nm) through the S-th hard coat from the object side, and
(Dc, s/Dfno, s)² is a value of (an area of the hard coat)/(an area of an effective region of rays based on an F number) on the optical surface to which the S-th hard coat from the object side is applied.

12. The optical imaging system according to claim 1, wherein the hard coat is formed in a circular shape centered on an optical axis of the optical component.

13. The optical imaging system according to claim 1, wherein a coat including diamond-like carbon is used as the hard coat.

14. The optical imaging system according to claim 1, wherein a coat including a silicon nitride film is used as the hard coat.

15. An imaging apparatus comprising:
an optical imaging system; and
an imaging device that converts an optical image, which is formed by the optical imaging system, into an electric signal,
wherein the optical imaging system has at least one optical component including an optical filter and a lens,
a hard coat is applied to an object side or an image side of an optical surface of the at least one optical component, and
the hard coat is formed to be able to come into contact with a different component positioned adjacent thereto or an optical surface of a different optical component positioned adjacent thereto.
